(19) United States
(12) Patent Application Publication
(10) Pub. No.: US 2007/0092674 A1
(43) Pub. Date: Apr. 26, 2007

(54) Multi-layered container for hazardous substances and process for producing the same

(75) Inventor: Boaz Gutwillig, Ein Hahoresh (IL)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Pachmas Metal Plastic & Fibre Industries, Ein Hahoresh (IL)

(21) Appl. No.: 11/604,669

(22) Filed: Nov. 27, 2006

Related U.S. Application Data
(63) Continuation-in-part of application No. PCT/IL04/00452, filed on May 27, 2004.

(51) Int. Cl. B32B 27/08

(52) U.S. Cl. 428/35.7

(57) ABSTRACT

A multi-layered container for hazardous substances that consists of co-extruded layers, where one of the layers comprises regrind material from all of the layers. When the container is bi-layered, the outer layer is produced from a mixture of virgin high-density polyethylene and regrind material from both the inner and outer layers, the regrind material ranges from 15 to 40% of the outer layer, and the thickness of the outer layer ranges from 90%-98% of the overall wall thickness of the container. When the container is tri-layered, the outer layer comprises HDPE, the intermediate layer comprises a mixture of HDPE and regrind material from the outer, intermediate, and inner layers, and the inner layer comprises a polyamide homopolymer.

### CROSS-REFERENCE TO RELATED APPLICATION(S)

This application is a continuation-in-part of PCT Application No. PCT/IL2004/000452 filed May 27, 2004, entitled BI-LAYERED CONTAINER FOR HAZARDOUS SUBSTANCES AND PROCESS FOR PRODUCING THE SAME.

### INCORPORATION BY REFERENCE

The aforementioned PCT Application No. PCT/IL2004/000452 is hereby incorporated by reference in its entirety.

### FIELD OF THE INVENTION

The present invention relates to the field of containers. More particularly, the invention relates to a co-extruded multi-layered container for hazardous substances.

### BACKGROUND OF THE INVENTION

Many prior art containers for hazardous substances, such as chemical products for use in agriculture, are formed by multi-layer co-extrusion blow molding. Each layer provides a different characteristic to the formed laminate.

In addition to having low permeability, high impact resistance, high stress crack resistance, and being chemically resistant to the hazardous substances to prevent damage to the surroundings, such containers are also preferably of low weight, high mechanical strength so that they will be commercially attractive, particularly to those working in agricultural applications.

Containers for hazardous substances are subjected to the following tests, according to the UN Recommendation for the Transport of Dangerous Goods:
Drop test, at −18° C. and at a height corresponding to the specific weight of the material being tested and the class of the material;
Leak proofness test, at 20 kPa above atmospheric pressure;
Internal pressure test, at 150 kPa above atmospheric pressure for 30 minutes; and
Stacking compression test, to demonstrate its dimensional stability and stress crack behavior, at a stacking height of 3 m which includes the height of the test sample and at a temperature of 40° C., for a duration of 28 days.

The inner layer, i.e. the barrier layer, needs to be essentially impermeable to the hazardous substance, particularly if it is a liquid or a gel. The barrier layer is generally made from polyamide, with a minimum thickness of 30 microns, to ensure that the container remains structurally strong and chemically stable.

The outer layer provides mechanical strength and stress crack resistance, to protect the contents of the container against mechanical shocks. Typically, the outer layer is made from high molecular weight HDPE.

The outer layer and inner layer are usually chemically incompatible, resulting in delamination, or separation, when co-extruded to adjacent layers. Consequently, an adhesive layer, such as modified polyolefin, is interposed between the outer and inner layers, to provide optimal bonding therebetween.

Many containers also employ a regrind layer made of melted scrap material, such as that which was removed during the pinching-off process during formation of the selected configuration of the container, so that the end product may be more cost effective. A typical four-layer agrochemical container may comprise, by percentage of volume, an inner layer of 8%, an adhesive layer of 5%, a mixture of HDPE and regrind material layer of 72% and an outer layer of 15%. When a regrind layer is not employed, the outer layer would have to comprise 87% by volume of the container, and therefore usage of a regrind layer significantly lowers manufacturing costs.

However, each of the three or four layers is produced by means of a separate extruder, with the extruded material being combined in a co-extrusion die to form a multi-layer parison, or tube-shaped mass of molten plastic material. The parison is then blow molded, whereby compressed gas, such as air, is injected into the interior of the parison, causing the latter to expand and to assume the contour of a closed mold, which is positioned to envelop the parison. The container is then demolded and deburred. As the number of container layers increase, the manufacturing process becomes correspondingly more complex and expensive.

It is an object of the present invention to provide a multi-layered container for hazardous substances.

It is an additional object of the present invention to provide a container which is made from material that is chemically resistant to the hazardous substances and that has a high impact resistance.

It is an additional object of the present invention to provide a multi-layered container in which each of its layers is chemically compatible and therefore does not require an additional adhesive layer.

It is an additional object of the present invention to provide a multi-layered container that can be economically produced.

Other objects and advantages of the invention will become apparent as the description proceeds.

### SUMMARY OF THE INVENTION

The present invention provides a multi-layered container for substances in liquid or gel form, particularly aromatic solvents, aliphatic solvents, ketones, kerosenes, alcohols and pesticides and herbicides that are dissolved in such solvents (also called Agro-chemicals), which may be filled into the multi-layered containers, all being injurious to humans or to animals when brought in contact with the skin, when swallowed, or when introduced to soil, sand and the like- hereinafter referred to as “hazardous substances.”

Said multi-layered container comprises two or more co-extruded layers blow molded to the shape of said container, wherein one of said layers comprises regrind material from all of said two or more layers.

In one embodiment, the multi-layered container is a bi-layered container. Said bi-layered container comprises co-extruded outer and inner layers, said outer layer comprising regrind material from said outer and inner layers.

Preferably, the outer layer is produced from a mixture of virgin high-density polyethylene, MAgPE (Maleic Anhydride Grafted Polyethylene CO-Polymer) ranging from 3-4% and regrind material from both the inner and outer layers, said regrind material ranging from 15-40%, and preferably 30%, of the outer layer. The outer layer has a thickness ranging from 90%-98% of the overall wall thickness of the container.

Suitable high-density polyethylene for providing mechanical strength and stress crack resistance has a melt flow index of 4.5-10.0 g/ 10 min (at 190° C./21.6 kg), a density of approximately 0.952 g/cm³, a yield strength of approximately 28 MPa when stretched at 50 mm/min, an elongation of greater than 700% at break, a flexural modulus of approximately 1200 MPa, a hardness of approximately 66 Shore D, a notched impact strength of approximately 100 KJ/m², and an environmental stress cracking resistance of greater than 400 hours.

In one preferred embodiment of the invention, the outer layer further comprises an MAgPE coupling agent having a density ranging between 0.956-0.960 g/cm³, a mass flow rate ranging between 2-3 g/10 min (at 190° C./2.16 kg), a melting point ranging between 133-136° C., a moisture content of less than 0.1%, and a Maleic Anhydride graft level of approximately 1.0% per weight. The coupling agent is mixed with the HDPE and the regrind material in the outer layer at a concentration ranging between 3-4% of the MAgPE, to bond the inner and outer layers without need of a separate adhesive layer.

In one aspect, the outer layer further comprises up to 2% of color concentrating Master Batch (MB).

Preferably, the inner layer is made from polyamide homopolymer, such as nylon, having a density of approximately 1.06 g/cm³, a notched impact strength of approximately 65 Charpy at 23° C. when dry and approximately 15 Charpy at −30° C. when dry, a permeability, when measured on 1-mm sheets, of approximately 0.42 g/m²-day for dioxane, 0.038 g/m²-day for N-Hexan, 0.13 g/m²-day for toluene, 0.41 g/m²-day for carbon disulphide, 2.8 g/m²-day for chloroform, and 0.03 g/m²-day for ethylether, a mass volume flow rate of approximately 35 ml/10 min at 275° C./5 kg, a melting point of approximately 222° C., and a moisture content of less than 0.3%. The thickness of the inner layer ranges from 30 to 100 microns.

In one preferred embodiment of the invention, the inner layer further comprises a maleic anhydride grafted polyethylene coupling agent having a density ranging between 0.956-0.960 g/cm³, a mass flow rate ranging between 2-3 g/10 min (at 190° C./21.6 kg), a melting point ranging between 133-136° C., a moisture content of less than 0.1%, and a maleic anhydride graft level of approximately 1.0% per weight. The coupling agent is mixed with the polyamide homopolymer in the inner layer at a concentration ranging between 0-4% of the MAgPE, to bond the inner and outer layers without need of a separate adhesive layer.

In another embodiment of the invention, the multi-layered container comprises co-extruded outer, intermediate, and inner layers, said outer layer comprising HDPE and said intermediate layer comprising a mixture of HDPE and regrind material from said outer, intermediate, and inner layers.

The regrind material ranges from 15 to 40 wt % of the intermediate layer.

The inner layer has a thickness ranges from 2% to 10% of the overall wall thickness of the container, and the intermediate layer has a thickness ranging from 15% to 30% of the overall wall thickness of the container.

Preferably, the HDPE has a melt flow index of 4.5-10.0 g/10 min (190° C./21.6 kg), a density of approximately 0.946-0.955 g/cm3, a yield strength of approximately 28 MPa when stretched at 50 mm/min, an elongation of greater than 700% at break, a flexural modulus of approximately 1200 MPa, a hardness of approximately 66 Shore D, a notched impact strength of approximately 100 kJ/m2, and an environmental stress cracking resistance of greater than 400 hours.

Preferably, the intermediate layer further comprises a maleic anhydride grafted polyethylene coupling agent (MAgPE) having a density ranging between 0.956-0.960 g/cm3, a mass flow rate ranging between 2-3 g/10 min at 190° C./2.16 kg, a melting point ranging between 133-136° C., a moisture content of less than 0.1%, and a maleic anhydride graft level of approximately 1.0% per weight, e.g. Fusabond E MB-100D. The coupling agent is mixed with the HDPE and the regrind material in the intermediate layer at a concentration ranging between 3 and 4 wt %.

Preferably, the outer layer further comprises up to 2% of MB.

Preferably, the inner layer comprises a polyamide homopolymer, e.g. nylon or Grilon BFZ 3.

In one aspect, the polyamide homopolymer has a density of approximately 1.06 g/cm3, a notched impact strength of approximately 65 Charpy at 23° C. when dry and approximately 15 Charpy at −30° C. when dry, a permeability, when measured on 1-mm sheets, of approximately 0.42 g/m2-day for dioxane, 0.038 g/m2-day for N-Hexan, 0.13 g/m2-day for toluene, 0.41 g/m2-day for carbon disulphide, 2.8 g/m2-day for chloroform, and 0.03 g/m2-day for ethylether, a mass volume flow rate of approximately 35 ml/10 min at 275° C./5 kg, a melting point of approximately 222° C., and a moisture content of less than 0.3%.

Preferably, the inner layer further comprises a maleic anhydride grafted polyethylene coupling agent having a density ranging between 0.956-0.960 g/cm3, a mass flow rate ranging between 2-3 g/10 min at 190° C./2.16 kg, a melting point ranging between 133-136° C., a moisture content of less than 0.1%, and a maleic anhydride graft level of approximately 1.0% per weight, e.g. Fusabond E MB-100D. The coupling agent is mixed with the polyamide homopolymer in the inner layer at a concentration ranging between 0 and 4 wt %.

The present invention also provides a process for producing a bi-layered container for hazardous substances, comprising producing outer layer material and inner layer material; regrinding scrap outer and inner layer material; mixing said reground scrap outer and inner layer material with said outer layer material; co-extruding outer and inner layers to form a bi-layered parison; blow molding said parison; and demolding and deburring said blow molded parison whereby to produce a marketable container.

In one aspect, the inner and outer layer material further comprises MAgPE, and the outer layer material further comprises MB.

Preferably, the reground scrap is fed into a mixer at a predetermined weight ratio of 15-40% by weight of the outer layer material.

In one aspect, the outer layer material is extruded at a temperature of 220° C. to 230° C. and the inner layer material is extruded at a temperature of 230° C. to 240° C.

In one aspect, the parison is pre-blown by inert gas, such as nitrogen. The inert gas is injected into the interior of the parison at approximately room temperature and at a pressure of less than 100 kPa.

The present invention also provides a process for producing a tri-layered container for hazardous substances, which container has an outer and intermediate layer made of a material comprising HDPE and an inner layer made of a material comprising a polyamide, said process comprising providing outer layer material, intermediate layer material, and inner layer material; regrinding scrap outer, intermediate, and inner layer material; mixing said reground scrap outer, intermediate, and inner layer material with said intermediate layer material; co-extruding outer, intermediate and inner layers to form a tri-layered parison; blow molding said parison; and demolding and deburring said blow molded parison; whereby to produce a marketable container.

In one aspect, the inner and intermediate layer material further comprises MAgPE, and the outer layer material further comprises MB.

In one aspect, the grains of the intermediate layer consisting of HDPE, reground scraps of the outer, intermediate, and inner layer material, and MAgPE are sorted into groups corresponding to each constituent material of a container and each group of grains is fed to a mixer at a predetermined weight ratio corresponding to the weight ratio of each constituent material in the container, excluding the regrind material.

### BRIEF DESCRIPTION OF THE DRAWINGS

In the Drawings:

FIG. 1 is a schematic drawing showing a laminate which is formed in accordance with one embodiment of the present invention;

FIG. 2 is a cross-sectional view of a co-extrusion device suitable for producing bi-layered containers;

FIG. 3A comparatively illustrates the weight loss rate of Xylene at 52° C. with 95% filling volume for the three types of tested containers as a function of time;

FIG. 3B comparatively illustrates the weight loss rate of Xylene at 52° C. with 95% filling volume for the three types of tested containers as a function of time, using more sensitive vertical scale; and

FIG. 4 is a schematic drawing showing a laminate which is formed in accordance with another embodiment of the present invention.

### DETAILED DESCRIPTION OF PREFEERED EMBODIMENTS

The present invention is a co-extruded multi-layered container for hazardous substances, wherein one layer is produced from regrind of all of the layers, including PA and HDPE, and in some cases, MAgPE and MB color concentrate, so that two adjacent layers are rendered chemically compatible, and therefore an adhesive layer is unnecessary.

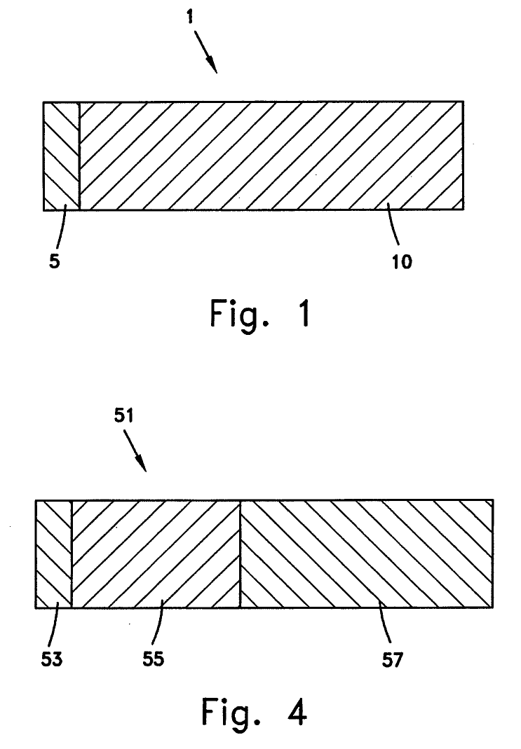

The Applicant has surprisingly discovered that a two-layered laminate is sufficient to prevent the outward diffusion of hazardous substances from a container produced from said laminate. As shown in FIG. 1, laminate 1 comprises inner layer 5 and outer layer 10. The thickness of the inner layer ranges from 30 to 100 microns, such that the outer layer has a thickness ranging from 90-98% of the overall wall thickness of the container.

Inner Layer 5 is made from an easily processable PA-6 grade polyamide homopolymer, e.g. Grilon BFZ 3 produced by EMS-Chemie AG, Switzerland (hereinafter referred to as PA), having a density of approximately 1.06 g/cm³, high impact strength such that its notched impact strength is approximately 65 Charpy at 23° C. when dry and is approximately 15 Charpy at −30° C. when dry, and a low permeability, when measured on 1-mm sheets, of approximately 0.42 g/m²-day for dioxane, 0.038 g/m²-day for N-Hexan, 0.13 g/m²-day for toluene, 0.41 g/m²-day for carbon disulphide, 2.8 g/m²-day for chloroform, and 0.03 g/m²-day for ethylether. PA has a mass volume flow rate (MVR) of approximately 35 ml/10 min at 275° C./5 kg, a melting point of approximately 222° C. and a moisture content of less than 0.3%.

In a preferred embodiment of the invention, the inner layer also comprises a maleic anhydride grafted polyethylene coupling agent, e.g. Fusabond E MB-100D manufactured by Dupont (hereinafter referred to as MAgPE) having a density ranging between 0.956-0.960 g/cm³, a mass flow rate (MFR) ranging between 2-3 g/10 min (at 190° C./2.16 kg), a melting point ranging between 133-136° C., a moisture content of less than 0.1%, and a maleic anhydride graft level of approximately 1.0% per weight. MAgPE is mixed with PA in the inner layer at a concentration ranging between 96-100% of PA.

Outer Layer 10 is made from a mixture of virgin high density polyethylene (HDPE) and regrind from both the inner and outer layers, and the MAgPE with concentration of 3-4 wt % of the outer layer, with the regrind material ranging from 15-40 wt %, and preferably 30 wt %, of the outer layer. MB color concentrate may be optionally added, as well.

Suitable HDPE for providing mechanical strength and stress crack resistance, e.g. Marlex 50100 manufactured by Chevron Phillips Chemical Company LP, Houston, Tex., USA and Hostalen GM 82.55 manufactured by Basell, Germany, has a melt flow index (MFI) 4.5-10.0 g/10 min (at 190° C./21.6 kg), a density of approximately 0.952 g/cm3, a yield strength of approximately 28 MPa when stretched at 50 mm/min, an elongation of greater than 700% at break, a flexural modulus of approximately 1200 MPa, a hardness of approximately 66 Shore D, a notched impact strength of approximately 100 KJ/m², and an environmental stress cracking resistance (ESCR) of greater than 400 hours.

The outer layer may also comprise up to 2 wt % MB, e.g. standard MB L 1125 white MB produced by Kafrit Industries Ltd., Kibbutz Kfar-Aza, Israel.

The scrap material which remains after the production of a plurality of containers is reground into grains of approximately 8 mm diameter, depending on the grinder net size. A feeding device, e.g. CD 400 manufactured by Sysmetric Ltd., Afula, Israel, sorts the grains into groups corresponding to each constituent material of a container. Each group of grains is fed to a mixer at a predetermined weight ratio corresponding to the exact weight ratio of each constituent material in the container, including the regrind material. “Regrind,” is defined herein as that mixed reground material. The mixed grains are introduced to the extruder, e.g. via a hopper at an inlet to the extruder.

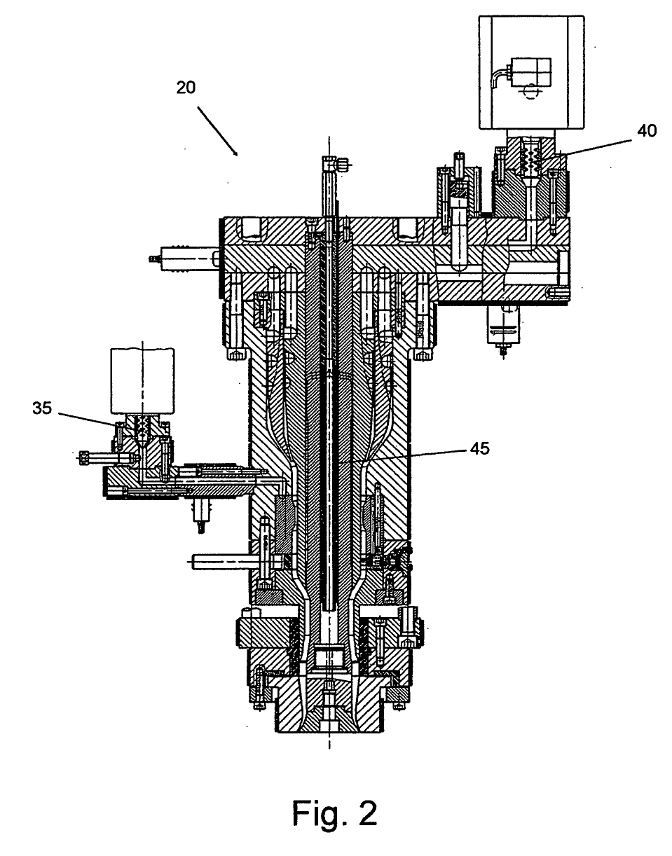

FIG. 2 illustrates an exemplary co-extrusion device, which is generally designated by numeral 20, suitable for the present invention. As seen, co-extrusion device 20 comprises main extruder (not shown) by which the outer layer is produced and satellite extruder 40 by which the inner layer is produced, as well as supplementary extruder 35 for producing transparent stripes. The inner and outer layers are co-extruded simultaneously.

Annular heating element 45 is mounted in the area subjacent to the inner surface of the conduit through which extruded material flows. Heating element 45, which is regulated by a controller (not shown), maintains the material forming the inner layer at a temperature of 230-240° C. This temperature range is suitable for the extrusion of PA. Since PA also is found in the outer layer as regrind, the outer layer needs to be heated to such a high temperature. Although this temperature is normally too high for the production of HDPE and is liable to impair the bonding characteristics thereof, the Applicant has surprisingly determined that containers produced according to the process of the present invention conform to the requirements of Israeli Standard No. 2302, IMDG Code, ADR-RID and ICAO-TI, as tested by The Standards Institute of Israel with respect to a drop test, leak proofness test, internal pressure test, and stacking compression test.

Following formation of a bi-layer parison is pre-blown, whereby compressed inert gas, such as Nitrogen, e.g. of room temperature and of a pressure less than 100 kPa, so as to increase the strength of the weld lines. Then the latter is blow molded by compressed air having a pressure of 10 bars. As a result, the parison expands and assumes the contour of a closed container mold, which is positioned to envelop the parison. The container is then demolded and deburred.

FIG. 4 illustrates another embodiment of the invention in which laminate 51 comprises inner layer 53, intermediate layer 55, and outer layer 57. The thickness of inner layer 53 ranges from 2-10% of the overall wall thickness of the container, and the thickness of intermediate Layer 55 ranges from 15-30% of the overall wall thickness of the container.

Inner Layer 53 is made from PA, and may also comprise a maleic anhydride grafted polyethylene coupling agent, e.g. MAgPE, mixed with the PA at a concentration ranging between 96-100 wt % of PA. Intermediate Layer 55 is made from a mixture of HDPE and regrind from all three layers, to ensure that the three layers are chemically compatible. The regrind material ranges from 15-40 wt % of intermediate layer 55. Intermediate layer may also comprise MAgPE, at a concentration of 3-4% thereof. Outer Layer 57 is made from HDPE, and may also comprise up to 2 wt % of MB color concentrate. A container made of three layers reduces the usage of MAgPE and MB.

### EXAMPLE 1

### Diffusion Tests of Organic Solvent in 10-liter Containers

10-liter containers were filled with Xylene, an organic solvent having a purity degree of 99.9%. Diffusion tests were conducted at the Israel Plastics and Rubber Center (IPRC) from Jul. 7, 2003 to Aug. 4, 2003, in order to determine the resistance of the containers to Xylene permeability.

Containers produced in accordance with the present invention were made with an inner layer of 100% PA (Grilon BFZ 3) and an outer layer comprised of a mixture of 70% HDPE (Hostalen GM 8255), 4% MAgPE (Fusabond E MB100D) and 1% white MB (L 1125). The outer layer also comprised regrind from the inner and outer layers, with a mixture of 25% regrind material.

The following four types of containers were employed:

T50- bi-layered container in accordance with the present invention having a 50-micron inner layer

T100- bi-layered container in accordance with the present invention having a 100-micron inner layer

HDPE- mono-layered container made of pure HDPE having a minimum wall thickness of 1.2 mm and an average thickness of 1.4 mm.

Ref- four-layered commercially available container produced by Aico Salconplast s.p.a, Italy having layers of PE/reg/tie/PA, with a 60-micron thick layer of PA.

Three repetitions of each container type were used, and each container was accordingly referred to with a suffix representing the repetition number. For example, T50-1 was the first repetition of container type T50.

The containers were placed in a temperature-controlled evaporation room for a duration of 28 days. The room temperature was stabilized at a temperature of 52-53° C. during the test period. Each container, including the cork and sealing film, was weighed before being filled with Xylene, at a filling volume of either 95% or 20%. After being filled, each container was sealed by a cork and a soldered aluminum film between the cork and container spout. The containers were weighed every four days with an accuracy of 0.01 g.

The test results were tabulated in Table 1. Each column indicates the percentage of the filling volume and the units of the tabulated value.

TABLE I

| | | Weight | | Weight |
|---|---|---|---|---|
| Container | Weight Loss | Difference | Weight Loss | Difference |
| Type | 95% [g] | 95% [%] | 20% [g] | 20% [%] |
| T50-1 | 3 | −0.035 | 1.95 | −0.101 |
| T50-2 | 4 | −0.045 | 2.10 | −0.108 |
| T50-3 | 2 | −0.024 | 2.30 | −0.119 |
| T100-1 | 2 | −0.023 | 3.50 | −0.185 |
| T100-2 | 2 | −0.023 | 2.20 | −0.146 |
| T100-3 | 2 | −0.024 | — | — |
| HDPE-1 | 719 | −8.224 | 414.90 | −21.12 |
| HDPE-2 | 723 | −8.218 | 417.05 | −21.08 |
| HDPE-3 | 719 | −7.905 | 412.95 | −21.22 |
| Ref-1 | 7 | −0.080 | 5.05 | −0.267 |
| Ref-2 | 8 | −0.090 | 4.70 | −0.251 |
| Ref-3 | 8 | −0.091 | 4.30 | −0.230 |

As can be clearly seen from Table 1, bi-layered T50 containers lost 0.035% of the filling weight at 95% volume filling and 0.109% at 20% volume filling. Bi-layered T100 containers lost 0.023% of the filling weight at 95% volume filling and 0.166% at 20% volume filling. In contrast, mono-layered HDPE containers lost 8.12% of the filling weight at 95% volume filling and 21.14% at 20% volume filling. Four-layered Reference containers lost 0.087% of the filling weight at 95% volume filling and 0.249% at 20% volume filling.

Therefore containers of the present invention demonstrated better performance in terms of blockade diffusion of aggressive organic solvents such as Xylene than four-layered Reference containers, by a factor on the order of 2.5, and better performance than pure HDPE containers, by a factor on the order of 235.

### EXAMPLE 2

### Diffusion Tests of Organic Solvent in 22-liter Containers

22-liter containers were filled with an organic solvent of a Xylene kind, having a purity degree of 99.9%. These containers were made with an inner layer of 96% PA (Grilon BFZ 3) and 4% MAgPE (Fusabond EMB 100D). The outer layer consists of a mixture of 65% HDPE (Hostalen GM 8255), 4% MAgPE (Fusabond EMB 100D), 1% white MB (L-1433) and 25% of regrind material from the inner and outer layers. Each container weight was 1.25 Kg. The inner layer's wall has a minimal thickness of 35 microns (50 microns average). The outer layer's wall has a minimal thickness of 1.5 mm (2 mm average).

The containers were placed in a temperature controlled evaporation room for 28 days. The room temperature was stabilized at 52-53° C. during the test period. All three types of containers that were tested (with four repetitions of each type) were filled up to 95% of their volume. Each empty container (including the cork and sealing film) was weighed prior to filling, and then was filled with each volume of the filling liquid. After filling, each container was sealed with a soldered aluminum film on its opening edge with the closing cork on top. The containers were weighed every four days (using a 1/100 g precision weight). During the test, the results were concentrated in Table I (for data analysis and control purposes after completing the test period). The test period was full 28 days.

The following types of containers were tested:
B20—22 Liters PE/PA bi-layered agro container with 50 microns barrier layer thickness, manufactured by the Applicant
BOXMORE—22 Liters agro container, with fluorinated HDPE inner face, manufactured by Boxmore International P.L.C. ,Newtownabbey, UK
HDPE ref.—22 Liters mono-layered pure HDPE agro container, manufactured by the Applicant

The test results are tabulated in Table II.

TABLE II

| | Xylene weight-loss | Net relative weight |
|---|---|---|
| | factor after 28 days | difference after 28 |
| | at 52° C. with 95% | days at 52° C. with |
| | filling volume | 95% filling volume |
| Container type | [grams] | [%] |
| B-20-1 | 1.1 | −0.03 |
| B-20-2 | 0.4 | −0.01 |
| B-20-3 | 1.4 | −0.03 |
| B-20-4 | 1.1 | −0.03 |
| BOXMOR-1 | 65.2 | −1.57 |
| BOXMOR-2 | 5.9 | −0.15 |
| BOXMOR-3 | 4.6 | −0.12 |
| BOXMOR-4 | 6.0 | −0.15 |
| HOPE Ref. -1 | 396.8 | −9.888 |
| HOPE Ref. -2 | 370.6 | −9.37 |
| HOPE Ref. -3 | 370.0 | −9.26 |
| HOPE Ref. -4 | 393.6 | −9.84 |

The above results show the following:
after 28 days at 52° C. with 95% filling volume bi-layered B-20 containers lost less than an average value of 0.03% of their filling weight;
after 28 days at 52° C. with 95% filling volume mono-layered HDPE Ref. containers lost less than an average value of 9.6% of their filling weight during accelerated evaporation test;
after 28 days at 52° C. with 95% filling volume fluorinated HDPE containers lost an average value of 0.5 % of their filling weight during accelerated evaporation test.

Therefore, containers manufactured according to the process proposed by the present invention show significant advantage regarding blocking diffusion of aggressive organic solvents, such as Xylene.

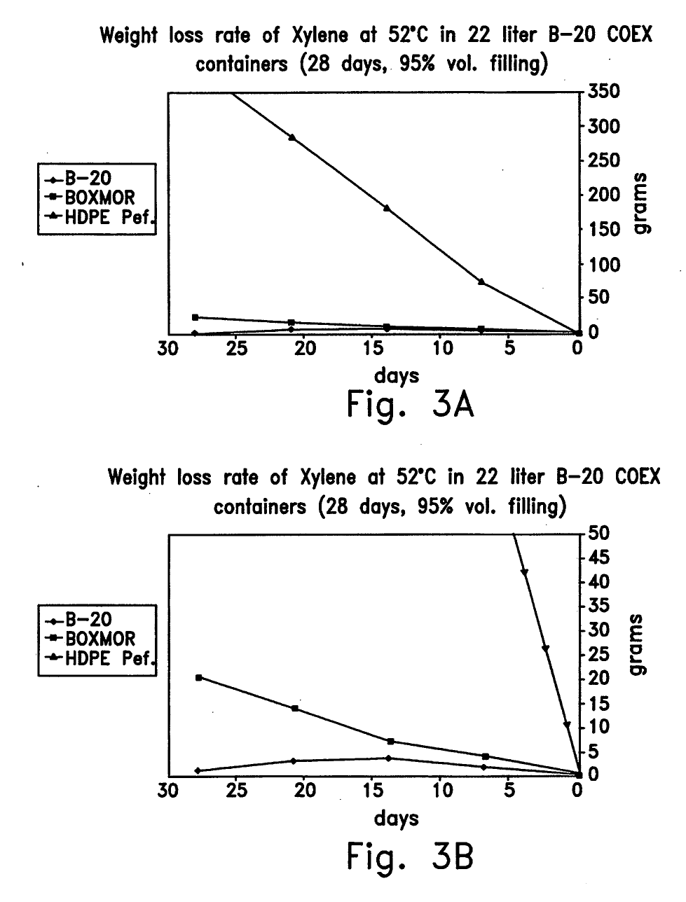

Experimental results of weight loss rate of Xylene at 52° C. with 95% filling volume are comparatively illustrated for the three types of tested containers as a function of time in FIGS. 3A and 3B (using 7 times more sensitive vertical scale).

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A multi-layered container for hazardous substances, comprising two or more co-extruded layers blow molded to the shape of said container, wherein one of said layers comprises regrind material from all of said two or more layers.

2. The multi-layered container according to claim 1, which is a bi-layered container, said bi-layered container comprising co-extruded outer and inner layers, said outer layer comprising a mixture of virgin high-density polyethylene (HDPE) and regrind material from said outer and inner layers.

3. The multi-layered container according to claim 2, wherein the regrind material ranges from 15 to 40 wt % of the outer layer.

4. The multi-layered container according to claim 3, wherein the regrind material comprises approximately 30 wt % of the outer layer.

5. The multi-layered container according to claim 2, wherein the outer layer has a thickness ranging from 90% to 98% of the overall wall thickness of the container.

6. The multi-layered container according to claim 2, wherein the high-density polyethylene has a melt flow index of 4.5-10.0 g/10 min (190° C./21.6 kg), a density of approximately 0.946-0.955 g/cm³, a yield strength of approximately 28 MPa when stretched at 50 mm/min, an elongation of greater than 700% at break, a flexural modulus of approximately 1200 MPa, a hardness of approximately 66 Shore D, a notched impact strength of approximately 100 kJ/m², and an environmental stress cracking resistance of greater than 400 hours.

7. The multi-layered container according to claim 2, wherein the outer layer further comprises a maleic anhydride grafted polyethylene coupling agent (MAgPE) having a density ranging between 0.956-0.960 g/cm³, a mass flow rate ranging between 2-3 g/10 min at 190° C./2.16 kg, a melting point ranging between 133-136° C., a moisture content of less than 0.1%, and a maleic anhydride graft level of approximately 1.0% per weight.

8. The multi-layered container according to claim 7, wherein the coupling agent is Fusabond E MB-100D.

9. The multi-layered container according to claim 7, wherein the coupling agent is mixed with the HDPE and the regrind material in the outer layer at a concentration ranging between 3 and 4 wt %.

10. The multi-layered container according to claim 2, wherein the outer layer further comprises up to 2% of color concentrating Master Batch (MB).

11. The multi-layered container according to claim 2, wherein the inner layer comprises a polyamide homopolymer.

12. The multi-layered container according to claim 11, wherein the polyamide homopolymer is nylon.

13. The multi-layered container according to claim 12, wherein the nylon is Grilon BFZ 3.

14. The multi-layered container according to claim 11, wherein the polyamide homopolymer has a density of approximately 1.06 g/cm³, a notched impact strength of approximately 65 Charpy at 23° C. when dry and approximately 15 Charpy at −30° C. when dry, a permeability, when measured on 1-mm sheets, of approximately 0.42 g/m2-day for dioxane, 0.038 g/m2-day for N-Hexan, 0.13 g/m2-day for toluene, 0.41 g/m2-day for carbon disulphide, 2.8 g/m2-day for chloroform, and 0.03 g/m2-day for ethylether, a mass volume flow rate of approximately 35 ml/10 min at 275° C./5 kg, a melting point of approximately 222° C., and a moisture content of less than 0.3%.

15. The multi-layered container according to claim 2, wherein the thickness of the inner layer ranges from 30 to 100 microns.

16. The multi-layered container according to claim 11, wherein the inner layer further comprises a maleic anhydride grafted polyethylene coupling agent having a density ranging between 0.956-0.960 g/cm³, a mass flow rate ranging between 2-3 g/10 min at 190° C./2.16 kg, a melting point ranging between 133-136° C., a moisture content of less than 0.1%, and a maleic anhydride graft level of approximately 1.0% per weight.

17. The multi-layered container according to claim 16, wherein the coupling agent is Fusabond E MB-100D.

18. The multi-layered container according to claim 16, wherein the coupling agent is mixed with the polyamide homopolymer in the inner layer at a concentration ranging between 0 and 4 wt %.

19. The multi-layered container according to claim 1, which comprises co-extruded outer, intermediate, and inner layers, said outer layer comprising HDPE and said intermediate layer comprising a mixture of HDPE and regrind material from said outer, intermediate, and inner layers.

20. The multi-layered container according to claim 19, wherein the regrind material ranges from 15 to 40 wt % of the intermediate layer.

21. The multi-layered container according to claim 19, wherein the inner layer has a thickness ranging from 2% to 10% of the overall wall thickness of the container, and the intermediate layer has a thickness ranging from 15% to 30% of the overall wall thickness of the container.

22. The multi-layered container according to claim 19, wherein the HDPE has a melt flow index of 4.5-10.0 g/10 min (190° C./21.6 kg), a density of approximately 0.946-0.955 g/cm³, a yield strength of approximately 28 MPa when stretched at 50 mm/min, an elongation of greater than 700% at break, a flexural modulus of approximately 1200 MPa, a hardness of approximately 66 Shore D, a notched impact strength of approximately 100 kJ/m², and an environmental stress cracking resistance of greater than 400 hours.

23. The multi-layered container according to claim 19, wherein the intermediate layer further comprises a maleic anhydride grafted polyethylene coupling agent (MAgPE) having a density ranging between 0.956-0.960 g/cm³, a mass flow rate ranging between 2-3 g/10 min at 190° C./2.16 kg, a melting point ranging between 133-136° C., a moisture content of less than 0.1%, and a maleic anhydride graft level of approximately 1.0% per weight.

24. The multi-layered container according to claim 23, wherein the coupling agent is Fusabond E MB-100D.

25. The multi-layered container according to claim 23, wherein the coupling agent is mixed with the HDPE and the regrind material in the intermediate layer at a concentration ranging between 3 and 4 wt %.

26. The multi-layered container according to claim 19, wherein the outer layer further comprises up to 2% of MB.

27. The multi-layered container according to claim 19, wherein the inner layer comprises a polyamide homopolymer.

28. The multi-layered container according to claim 27, wherein the polyamide homopolymer is nylon.

29. The multi-layered container according to claim 28, wherein the nylon is Grilon BFZ 3.

30. The multi-layered container according to claim 27, wherein the polyamide homopolymer has a density of approximately 1.06 g/cm³, a notched impact strength of approximately 65 Charpy at 23° C. when dry and approximately 15 Charpy at −30° C. when dry, a permeability, when measured on 1-mm sheets, of approximately 0.42 g/m2-day for dioxane, 0.038 g/m2-day for N-Hexan, 0.13 g/m2-day for toluene, 0.41 g/m2-day for carbon disulphide, 2.8 g/m2-day for chloroform, andO.03 g/m2-day for ethylether, a mass volume flow rate of approximately 35 ml/10 min at 275° C./5 kg, a melting point of approximately 222° C., and a moisture content of less than 0.3%.

31. The multi-layered container according to claim 27, wherein the inner layer further comprises a maleic anhydride grafted polyethylene coupling agent having a density ranging between 0.956-0.960 g/cm³, a mass flow rate ranging between 2-3 g/10 min at 190° C./2.16 kg, a melting point ranging between 133-136° C., a moisture content of less than 0.1%, and a maleic anhydride graft level of approximately 1.0% per weight.

32. The multi-layered container according to claim 31, wherein the coupling agent is Fusabond E MB-100D.

33. The multi-layered container according to claim 31, wherein the coupling agent is mixed with the polyamide homopolymer in the inner layer at a concentration ranging between 0 and 4 wt %.

34. A process for producing a bi-layered container for hazardous substances, which container has an outer layer made of a material comprising HDPE and an inner layer made of a material comprising a polyamide, said process comprising providing outer layer material and inner layer material; regrinding scrap outer and inner layer material; mixing said reground scrap outer and inner layer material with said outer layer material; co-extruding outer and inner layers to form a bi-layered parison; blow molding said parison; and demolding and deburring said blow molded parison; whereby to produce a marketable container.

35. The process according to claim 34, wherein the inner and outer layer material further comprises MAgPE.

36. The process according to claim 35, wherein the outer layer material further comprises MB.

37. The process according to claim 36, wherein the grains of the outer layer consisting of HDPE, reground scraps of the inner/outer layer material, MAgPE and MB are sorted into groups corresponding to each constituent material of a container and each group of grains is fed to a mixer at a predetermined weight ratio corresponding to the weight ratio of each constituent material in the container, excluding the regrind material.

38. The process according to claim 34, wherein the outer layer material is extruded at a temperature of 220° C. to 230° C. and the inner layer material is extruded at a temperature of 230° C. to 240° C.

39. The process according to claim 34, wherein the parison is pre-blown by inert gas.

40. The process according to claim 39, wherein the inert gas is nitrogen.

41. The process according to claim 39, wherein the inert gas is injected into the interior of the parison at approximately room temperature and at a pressure of less than 100 kPa.

42. A process for producing a tri-layered container for hazardous substances, which container has an outer and intermediate layer made of a material comprising HDPE and an inner layer made of a material comprising a polyamide, said process comprising providing outer layer material, intermediate layer material, and inner layer material; regrinding scrap outer, intermediate, and inner layer material; mixing said reground scrap outer, intermediate, and inner layer material with said intermediate layer material; co-extruding outer, intermediate and inner layers to form a tri-layered parison; blow molding said parison; and demolding and deburring said blow molded parison; whereby to produce a marketable container.

43. The process according to claim 42, wherein the inner and intermediate layer material further comprises MAgPE.

44. The process according to claim 43, wherein the outer layer material further comprises MB.

45. The process according to claim 44, wherein the grains of the intermediate layer consisting of HDPE, reground scraps of the outer, intermediate, and inner layer material, and MAgPE are sorted into groups corresponding to each constituent material of a container and each group of grains is fed to a mixer at a predetermined weight ratio corresponding to the weight ratio of each constituent material in the container, excluding the regrind material.
